(19) United States
(12) Patent Application Publication
(10) Pub. No.: US 2002/0174553 A1
(43) Pub. Date: Nov. 28, 2002

(54) Adjustable level

(76) Inventors: Calvin W. Dolezal, Lester Prairie, MN (US); Ervin J. Pundsack, Winsted, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/119,532

(22) Filed: Apr. 8, 2002

Related U.S. Application Data
(60) Provisional application No. 60/282,606, filed on Apr. 9, 2001.

(51) Int. Cl. G01C 9/00

(52) U.S. Cl. 33/373

(57) ABSTRACT

The present invention provides a leveling apparatus which is capable of gripping items to be leveled, such as pipes and poles. The invention further contemplates a one piece level for leveling flat surfaces.

### RELATED APPLICATIONS

This application claims priority to provisional application No. 60/282,606, filed Apr. 9, 2001, which is herein incorporated by reference in its entirety.

### FIELD OF THE INVENTION

This invention relates generally to an adjustable level. More particularly, the present invention is directed to an adjustable level which may be used to plumb posts and pipes of any shape and size.

### BACKGROUND OF THE INVENTION

Spirit or bubble levels used to plumb vertical posts, pipes or poles are well known. For example, U.S. Pat. No. 392,124 to Jackson describes a spirit level attachable to a vertical post with screws. U.S. Pat. No. 3,826,013 to Baher describes a post level with right-angular arms adapted to engage a circumferential surface of a post. The post level is hand-held against the post and bubble vials indicate the degree of verticality of the post.

U.S. Pat. No. 6,029,359 to Szumer describes post level including a pair of arms pivotally attached to each other at a hinge, each arm defining at least one level face for plumbing a surface, and at least one bubble vial mounted on at least one of the arms on a surface generally opposite to the at least one level face, wherein the arms may be swung about the hinge so as to be positioned generally parallel with each other with the at least one bubble vial being between the arms.

U.S. Pat. No. 2,727,314 to Dossie et al. describes a post level which allows plumbing both sides of a vertical corner post simultaneously. This device uses an extended plumbing surface with mirrors to view the bubble vials.

U.S. Pat. No. 5,207,004 to Gruetzmacher describes a post level defined by a pair of right-angle, non-hinged, rigid walls. A horizontal bubble vial is mounted in each wall, and a vertical bubble vial is mounted at the intersection of the walls.

U.S. Pat. No. 4,976,040 to Mish et al. describes a post level with a pair of columnar level bodies attachable to a post with elastic bands.

U.S. Pat. No. 4,343,093 to Eadens describes a post level including a pair of right-angle hinged arms with an orbital bubble vial, known as a “bull's-eye type” bubble vial, mounted on one of the arms. A chain may be wrapped around a post to attach the level thereto.

### SUMMARY OF THE INVENTION

Without limiting the scope of the invention a brief summary of the claimed embodiments of the invention is set forth below. Additional details of the summarized embodiments of the invention and/or additional embodiments of the invention may be found in the Detailed Description of the Invention below.

The present invention seeks to provide a novel level which may serve as a post or pipe level. In other words, the level of the present invention may be used to plumb any vertical pole or post of any arbitrary cross section and may also be used to horizontally set an object. The present invention also contemplates leveling at an angle.

The adjustable level may be securely attached to the item to be leveled so as to free both hands of the user for positioning and securing the object while the user maintains a visual check on the bubble level for precise plumbness.

In the preferred embodiment, the adjustable level comprises an apparatus which is capable of grasping the item to be leveled. In the primary embodiment of the invention, the invention comprises an upper member and a lower member. The upper and lower members are connected via an adjustable mechanism. In the embodiments disclosed in the figures, the mechanism may be a pair of rods which allow the upper member to be drawn toward the lower member, grasping an item, such as a pipe or a pole, leaving the users hands free to adjust the item which is being leveled.

The upper member may be one piece. Preferably, the upper member comprises multiple pieces, portions or members. In this instance, the upper member comprises a front member and an opposing back member, the two members being separated by a spacer piece. The upper member further comprises a top member mounted on the spacer piece. The top member houses the spirit vials which aids in leveling the subject item. The spirit vials are held at different angles.

The opposing bottom member preferably comprises one piece. The bottom member may be drawn toward the upper member via the adjustable mechanism. The inner portions of the upper and lower members are configured so as to easily grip the item to be plumbed. In the embodiments shown, this configuration is V-shaped.

All patent and applications and all other published documents mentioned anywhere in this application are incorporated herein by reference in their entirety.

### BRIEF DESCRIPTION OF THE DRAWINGS

FIG. 1 is a front perspective view of an embodiment of the adjustable level;

FIG. 2 is a front view of the upper member of an embodiment of the adjustable level;

FIG. 3 is a side view of the upper member of an embodiment of the adjustable level;

FIG. 4 is a front view of the upper member of an embodiment of the adjustable level;

FIG. 4A is a top view of a portion of the upper member of an embodiment of the adjustable level along lines A-A, as shown in FIG. 4;

FIG. 5 is a side view of the upper member of an embodiment of the adjustable level;

FIG. 5A is an isolated side view of a portion of the upper member of an embodiment of the adjustable level, as shown in figure;

FIG. 6 is a front view of the lower member of an embodiment of the adjustable level;

FIG. 7 is a side view of the lower member of an embodiment of the adjustable level;

FIG. 8 is a bottom view of the lower member of an embodiment of the adjustable level;

FIG. 9 is a front view of an embodiment of the adjustable level;

FIG. 9A is a bottom and side view of a bushing positioned in an embodiment of the adjustable level as indicated in FIG. 9;

FIG. 10 is a side view of an embodiment of the adjustable level;

FIG. 10A is a bottom and side view of a spacer positioned in an embodiment of the adjustable level as indicated in FIG. 9;

FIG. 11 is a schematic of the adjustment rod used in joining the upper and lower members;

FIG. 11A is a schematic of the pins which engage the tops of the adjustment rods between the front and back members.

FIG. 12 is a side view of an embodiment of the invention holding an item to be leveled; and

FIG. 13 is a perspective view of an embodiment of the invention holding an item to be leveled.

### DETAILED DESCRIPTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, unless otherwise indicated, identical reference numerals used in different figures refer to the same component.

A detailed description of illustrative embodiments of the leveling according to the invention is given herein below with reference to the attached drawings, and possible modifications are discussed by way of conclusion.

The following statement applies to the whole of the description. If, for the purposes of clarity of the drawings, reference numbers are included in a figure but are not mentioned in the directly associated text of the description, then reference is made to their mention in preceding figure descriptions. In the interests of intelligibility, the repeated designation of components in succeeding figures is for the most part omitted, if it is clear from the drawings that the components concerned are recurring components.

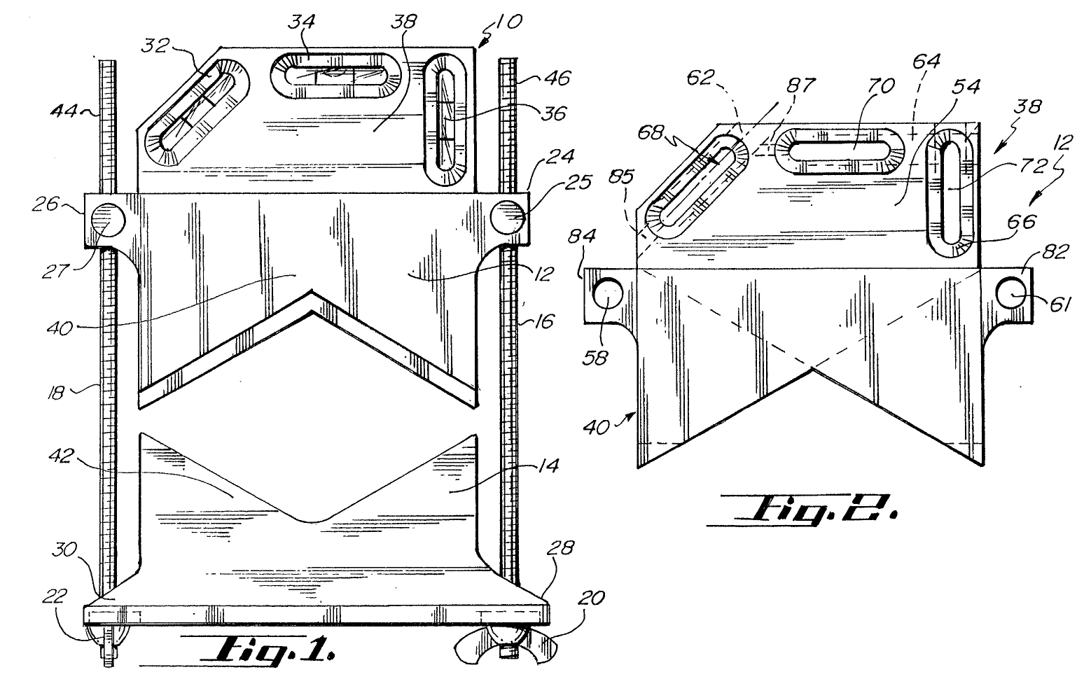

The present invention is an adjustable level which is configured to engage items which are difficult to adjust. FIG. 1 shows a perspective view of embodiment of the invention. The level 10 comprises an upper member 12 and a lower member 14 adjustably connected together. In this particular embodiment, the upper 12 and lower 14 members are adjustably connected to each other via rods 16 and 18. In this case, the rods are threaded to receive wing nuts 20, 22. As seen in FIG. 1, the rods are held in place by the upper member 12 at portions 24 and 26, stationary relative thereto, and slidably received by the lower member 14 at portions 28 and 30. This arrangement allows the members 12, 14 to be brought together along the line of the rods to engage the item which is to be leveled.

In this particular embodiment, portions 24 and 26 have openings (not shown) through which the rods 16, 18 are inserted. In this embodiment, pins 25 and 27 adjustably hold the rods 16, 18 in place. This securement mechanism may take many forms. The mechanism used should be capable of securing the rods 16, 18 in place, preferably in an adjustable manner such that the rods 16, 18 may be adjusted.

In this particular embodiment, spirit vials 32, 34, 36 are incorporated into the upper member 12. The vials are inset into the upper member 12 at angles helpful to the user. As will be explained later, the vials may be view from both sides, as well as from the top and sides. FIG. 1 shows the vials in positions relative to the level which include a 45° 32, horizontal 34 and vertical 36, respectively. In this embodiment the vials are inset into the upper portion 38 upper member 12, although this is not necessary for the invention. It should be understood that other variations of this mechanism may be chosen.

The bottom portion 40 of the upper member 12 is shaped so as to receive the item which is to be leveled. In FIG. 1, the bottom portion is configured to have an upside down “V” shape. It should be understood that the shape of the bottom portion 40 may be in a number of configurations as long as the invention is capable of engaging and holding the item to be leveled. Typically, the item is tubular. As such, the embodiment shown incorporates opposing “V” shapes to securely hold a tubular object.

In the embodiment of FIG. 1, the upper member is shown as a one piece unit. As will be explained later, the upper member is preferably a multi-piece or multi-portion unit.

The lower member 14 includes a top portion 42 which similarly has a “V” shaped configuration, opposingly situated to the bottom portion 40 of the upper member 12. The top portion 42 and the bottom portion 40 work together in a coordinated manner so as to securely grasp the item to be leveled. As mentioned above, the shape of the top portion 42 may be in a number of configurations as long as the invention is capable of engaging and holding the item to be leveled

The upper member 12 and the lower member 14 are held together by an adjustment mechanism. The purpose of the adjustment mechanism is to draw the upper member 12 and the lower member 14 together to grasp the item to be leveled. It should be understood that the mechanism which draws the upper member 12 and the lower member 14 together may take a number of forms. However, in the preferred embodiment shown in FIG. 1, the mechanism takes the form of a pair of bolts/rods 16, 18 secured to the upper member 12 through portions 24 and 26 and to the lower member 14 through portions 28 and 30. This allows the user to draw the two the members together. This mechanism allows the user to easily adjust the positioning of the members 12, 14 relatively to one another.

The upper portion of the rod 44 is held in place by the upper member at portion 26. The rod may be repositioned and secured at this portion. However, the main purpose of portion 26 is to hold the rod 18 so that the distance between the upper member 12 and the lower member 14 may be adjusted from the connection between the rod 18 and the lower member 14 at portion 30.

Portion 30 includes a opening through which the rod 18 extends. The bottom end of the rod 18 is engaged by a wing nut 22. It should be understood that the mechanism which adjusts the distances between the members may take many forms. In this particular case as shown in FIG. 1, the wing nut 22 allows the user to draw the lower member 14 toward the upper member 12.

The upper portion of the rod 46 is held in place by the upper member at portion 24. The rod may be repositioned and secured at this portion. However, the main purpose of portion 24 is to hold the rod 16 so that the distance between the upper member 12 and the lower member 14 may be adjusted from the connection between the rod 18 and the lower member 14 at portion 28.

Portion 24 includes a opening through which the rod 16 extends. The bottom end of the rod 16 is engaged by a wing nut 22. It should be understood that the mechanism which adjusts the distances between the members may take many forms. In this particular case as shown in FIG. 1, the wing nut 22 allows the user to draw the lower member 14 toward the upper member 12.

The embodiments shown in the figures have 3 level vials inset within the upper portion 38 of the upper member 12. It should be understood that the number and location of the vials may be dictated by the needs of the user. It should also be understood that the upper member 12 may be removed from the lower member 14 and be used by itself as a level on any surface.

The remaining figures illustrate the invention in detail. The upper member 12 of the embodiment of the remaining figures comprises multiple pieces or portions, as apposed to the one-piece construction of the embodiment of figure on. However, it should be understood that the remaining characteristics are interchangeable.

FIG. 2 is a front view of the upper member 12. In this particular embodiment, the lower portion 40 of the upper member 12 forms an upside down “V”. The level vials 32, 34, 36 are positioned in the upper portion 38. A side view, as shown in FIG. 3, of the upper member 12 illustrates the portions which make up the upper member 12. The upper member 12 comprises a front member 48 and a back member 50 connected by spacer piece 52. The upper portion comprises a top member 54, which incorporates the level vials. The upper portion is connected to or is formed into the spacer piece 52. It should be understood that the interconnection between the portions may be accomplished in other ways such as welding or adhering. A relief hole 56 extends from bored hole 66. Similar relief holes 85, 87 are found as extensions of bored holes 62 and 64. The relief holes are extensions of the bored holes for the release of air when removing and inserting the level vials.

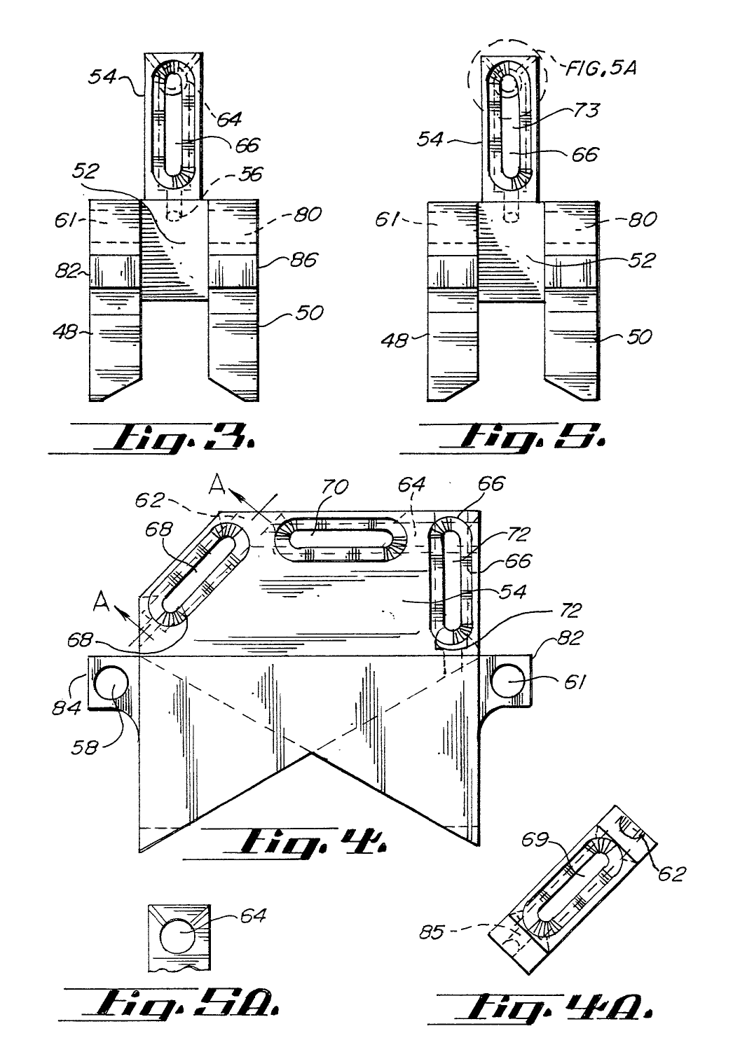

Front member 48 also comprises portions 82 and 84, which incorporate holes 61 and 58. The opposing back member 50 comprises mirroring portions 86 and 88 (seen in FIG. 13) and holes 80 (remaining hole of back member 50 not shown). These mirroring holes in the multi-piece upper member 12 hold the pins 60, 90, which in turn hold the top portions of rods 16 and 18. FIGS. 3 and 5 show in phantom lines hole 61 and 80 through which pin 60 (as with pin 90, both seen in FIGS. 12-13) is inserted to hold the front member 48 and the back member 50 together, if not already secured together, as well as holding the level rod 16 in place relative to the upper member 12. This holds true in mirror image with pin 90 and rod 18.

It should be understood that, although upper member 12 is referred to as multi-piece, the various portions or pieces may be formed by machining a single piece. As such, pieces and members of the upper member 12 may also be thought of as portions of a machined upper member 12.

FIGS. 4, 4A, 5A and 5 further illustrate the upper portion 12. FIG. 4 shows a more detailed view of the front of the upper member 12. FIG. 4A shows a top view of the angled level vial. As can be seen in phantom lines, the top member 54 has bored holes 62, 64, 66 into which the level vials 32, 34, 36 may be inserted. The figures show the bored holes at certain angles to receive the vials. In this particular embodiment, bored hole 64 crosses bored hole 66. In this case, vial 34 is inserted first into bored hole 64. Vial 36 is then inserted into bored hole 66. The side views of FIGS. 5 and 5A illustrate the end of bored hole 64.

Windows or openings 68, 70, 72 are incorporated to view the level vials. The edges of the windows are beveled for easier viewing. However, this not necessary for the invention. FIG. 4A further illustrates bored hole 62 and at a window 69 and the placement of the vial 32 within the bored hole 62. Window 69 is viewed from the top of the upper portion 38. Bored hole 64 can also be seen from the top via window 71. Vial 36 can also be seen via window 73 as shown in FIG. 5. As can be seen, the vials are at angles which are likely to be most useful to the user. FIG. 5A shows a more detailed look at the end of bored hole 64. It demonstrates the machining of the indicated portion of FIG. 5.

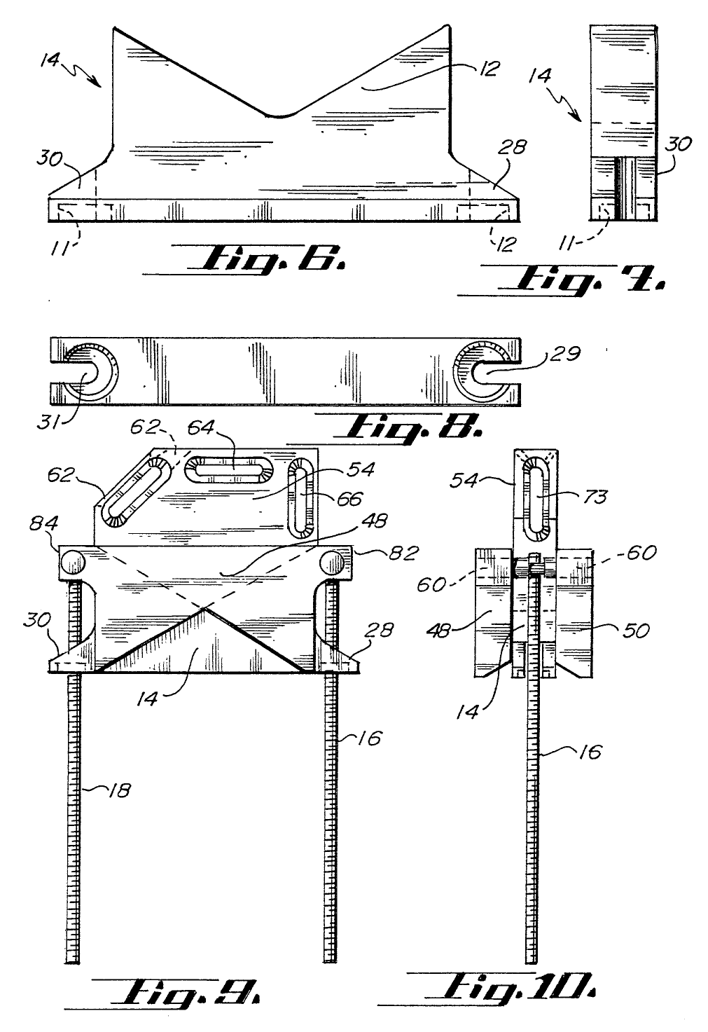

FIG. 6 illustrates the front of the lower member 14. In this particular embodiment, the upper portion 42 of the lower member 14 forms a “V”. As mention above, it should be understood that the shape of the top portion 42 may be in a number of configurations as long as the invention is capable of engaging and holding the item to be leveled. Unlike the upper member 12, which may comprise more than one piece, the lower member is preferably one piece. However, the invention contemplates an embodiment in reverse fashion, wherein the lower member comprises multiple pieces, while the upper member comprises a single piece.

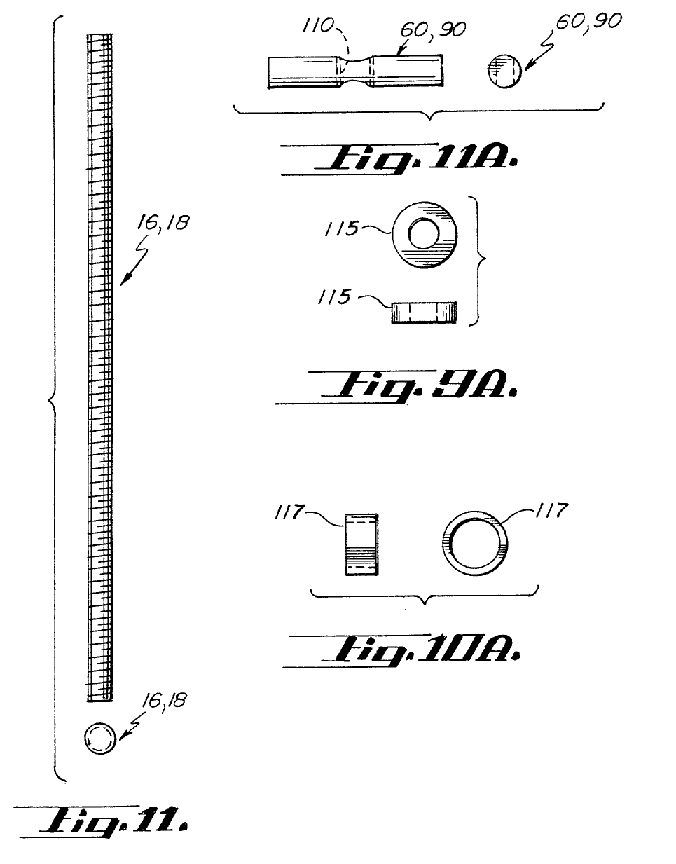

A side view and a bottom view of the lower member 14 are shown in FIGS. 7 and 8. Portions 28 and 30 receive the bottom of rods 16 and 18 through openings 29 and 31. Although the openings 29 and 31 may take a number of configurations, the present embodiment takes the form of a slotted opening allowing a loosened rod to be separated from the lower portion 14 from the side. The figures also utilize phantom lines to illustrate this embodiment. For example, Recess portions 111 and 112 can be seen in FIGS. 6 and 7. These recesses are formed to receive bushings as described below.

FIGS. 9, 9A, 10 and 10A illustrate one embodiment of the entire level, wherein the upper member 12 is multi-pieced or multi-portioned and the lower member 14 is single-pieced, as described above. FIG. 9 shows the lower member 14 fully drawn up toward the upper member 12. As can be seen, the single piece lower member 14 is drawn up in between the front member and the back member of the upper member 12. The wing nuts are not shown. FIG. 10 shows a side view illustrating how lower member 14 fits between the front and back members of the upper member 12. This allows the level to engage smaller diameter pipes.

As mentioned above, it is contemplated that the upper member may be one piece, as in FIG. 1, while the lower member is multi-pieced, as described with regard to the upper member in FIGS. 2-5. This may be achieved simply by incorporating the spirit vials into the lower member 14 rather than the upper member 12.

FIG. 9A shows a bottom and side view of bushings B, having openings 115, preferably metal, for the wing nuts 20, 22 to spin on. These bushings are incorporated within portions 28 and 30, through which the rods 16, 18 are inserted. It should be understood, as mentioned above, that these receiving holes may be slotted.

FIG. 10A shows a front and side view of the spacers A, having openings 117, which hold the threaded rods 16, 18 on center between the front and back members 48, 50. The spacers are on the cross-bar/pins 60, 90 on either side of the threaded rods 16, 18. The tops of the threaded rods are engaged by the pins 60, 90.

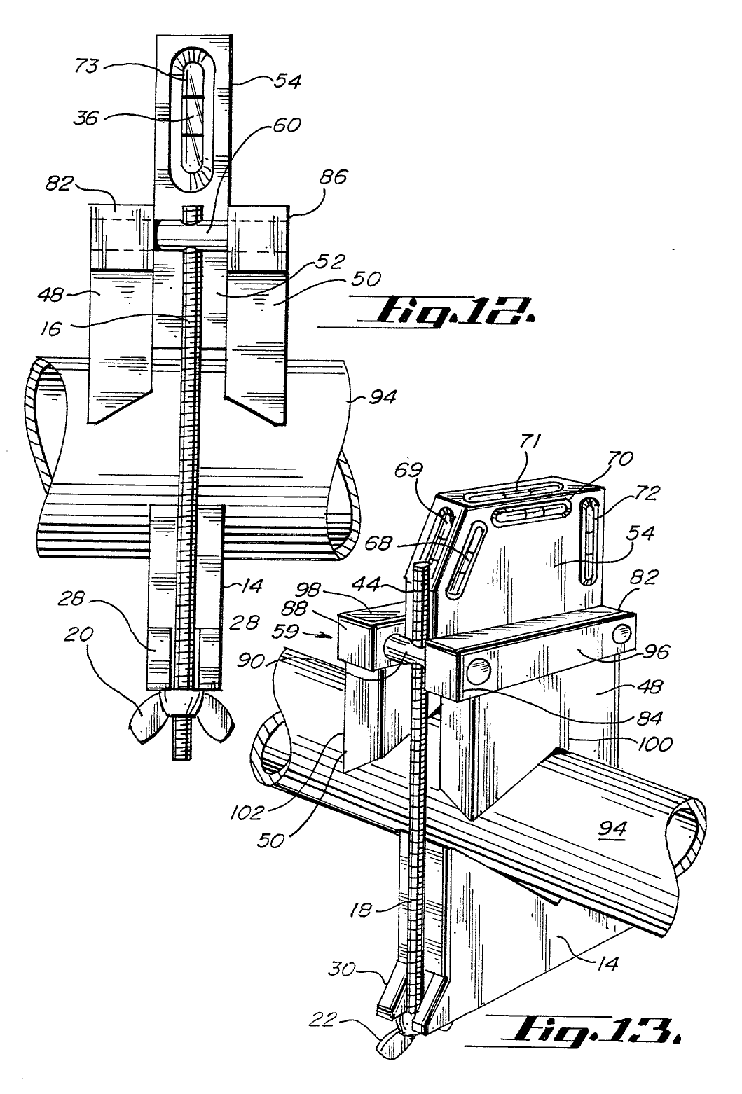

FIGS. 11 and 11A illustrate the rods 16, 18 and the pins 60, 90. FIG. 11 shows a side view and a cross-section view of rods 16 and 18. The rods are preferably threaded on either end and made of metal or plastic. The threading along the rods may extend the full length of the rods. FIG. 11A illustrates pins 60, 90, which hold the upper portions of rods 18 and 16. Pins 60 and 90 have a hole 110, preferably threaded, which receives rods 16 and 18.

FIGS. 12 and 13 show the level in use holding a portion of a tube 94. The figures illustrate how the level grips the item to be leveled. FIG. 12 shows the level from the side view window 73 of bored hole 66. Most of the elements labeled have been discussed above. The spatial relationship between the upper member 12 and the lower member 14 can easily be seen. The spacer 52 separates the front member 48 from the back member 50. Portions 82 and 86 can be seen securely holding pin 60 in holes 61 and 80, which in turn receives and holds rod 16. The bottom of rod 16 is held in hole 29 of portion 28.

More attributes maybe seen in FIG. 13 which shows a perspective view of the other side of the level. The vials may be seen from the side windows 68, 70, 72, mirroring the windows (not shown) on the opposite side of the top member 54. Portions 84 and 88 can be seen securely holding pin 90 in holes 58 and 59, which in turn receives and hold rod 18. The bottom of rod 18 is held in hole 31 of portion 30.

The embodiment in FIG. 13 shows the front and back members 48, 50 comprising top bars 96, 98. Top bar 96 ends in portions 84 and 82 and top bar 89 ends in portions 86 and 88. The front and back members 48, 50 may be of one piece construction or may comprise the top bars connected to gripping portions 100, 102. The pieces may be connected via suitable methods, such as welding or adhering.

A number of materials may be used for the construction of the level, preferably, metal and/or plastic, or a combination thereof.

In addition to being directed to the embodiments described above and claimed below, the present invention is further directed to embodiments having different combinations of the dependent features described above and/or claimed below.

Various changes and modifications can be made to the present invention. It is intended that all such changes and modifications come within the scope of the invention as set forth in the following claims.

Elements not identified in a particular figure are readily identifiably via their identification in other figures.

It should be understood that individual features of the above embodiments may stand alone as improvements or may be combined with each other in multiple configurations where physically possible. The proportional representation illustrated by the figures also represents structural disclosure of various embodiments.

If not described in detail above, the proportions and relative construction of the embodiments may be interpreted from the figures. Any inconsistencies between the figures and the description should be seen as alternative embodiments. Variations in the relative construction which do not change the inventive concepts presented herein are contemplated as possible embodiments of the invention.

The above examples and disclosure are intended to be illustrative and not exhaustive. These examples and description will suggest many variations and alternatives to one of ordinary skill in this art. All these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each single dependent claim format which creates a dependency from a prior antecedent-possessing claim other than the specific claim listed in such dependent claim below (e.g. claim 6 may be taken as alternatively dependent from any of claims 2-5, claim 4 may be taken as alternatively dependent from claim 3; etc.).

What is claimed is:

1. An adjustable leveling device comprising,
an upper member, the upper member comprising at least one spirit vial;
a lower member opposingly situated relative to the upper member; and
at least one adjustable connecting mechanism, the at least one adjustable connecting mechanism connecting the upper member to the lower member, whereby the lower member may be drawn toward the upper member to grasp an item to be leveled.

2. The leveling device of claim 1, wherein there are two adjustable connecting mechanisms, both individually being connected to the upper member and the lower member.

3. The leveling device of claim 2, wherein the two connecting mechanisms are individually adjustable.

4. The leveling device of claim 1, wherein the upper member has three spirit vials.

5. The leveling device of claim 2, the upper member comprising a front member and a back member, the front member and back member being connected to one another, wherein there is a space between the front member and the back member.

6. The leveling device of claim 5, wherein the lower member may be drawn toward the upper member such that the lower member is in the space between the front and back members.

7. The leveling device of claim 1, wherein the upper member has a lower portion, the lower portion forming a “V” shape, and the lower member has an upper portion, the upper portion forming a “V” shape which is opposingly situated relative the “V” shape of the lower portion of the upper member.

8. The leveling device of claim 3, wherein the connecting mechanisms are rods, each having first ends and second ends, the first ends being in connection with the upper member and the second ends being in connection with the lower member.

9. The leveling device of claim 7, wherein the upper member has a lower portion, the lower portion forming a “V” shape, and the lower member has an upper portion, the upper portion forming a “V” shape which is opposingly situated relative the “V” shape of the lower portion of the upper member.
